(19) United States
(12) Patent Application Publication
(10) Pub. No.: US 2012/0240083 A1
(43) Pub. Date: Sep. 20, 2012

(54) ELECTRONIC DEVICE AND NAVIGATION DISPLAY METHOD

(75) Inventors: WEI SONG, Shenzhen City (CN); XIAO-GUANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/187,467

(22) Filed: Jul. 20, 2011

(30) Foreign Application Priority Data
Mar. 18, 2011 (CN) 201110065332.4

(51) Int. Cl. G06F 3/048

(52) U.S. Cl. 715/839

(57) ABSTRACT

An electronic device includes an input unit receiving operations of a users and generates input signals based on the operations of the user. A display unit displaying an interface with a content display area and an address display area under a current file path. The current file path presented by at least one folder icon, each of the at least one folder icon corresponding to a level of the hierarchy of the current file path. In addition, a processing unit updating the current file path according to the operations of the user to open a selected file or a selected folder or a selected link, and updating the content in the content display area accordingly. A navigation display method is also provided.

### BACKGROUND

1. Technical Field

The present disclosure relates to electronic devices and methods for displaying file paths and, particularly, to an electronic device and a navigation display method for displaying file paths capable of saving space of the address bar in a window.

2. Description of the Related Art

When users search for a desired file, the file paths are displayed on the address bar in an interface. If the path of the desired file is too long, it is difficult for the tediously long paths to be completely displayed on the address bar, especially for small electronic devices with a limited display space, such as electronic readers or mobile phones, which is inconvenient for users.

### BRIEF DESCRIPTION OF THE DRAWINGS

The components of the drawings are not necessarily drawn to scale, the emphasis instead being placed upon clearly illustrating the principles of an electronic device and display method of file paths thereof. Moreover, in the drawings, like reference numerals designate corresponding parts throughout multiple views.

FIG. 1 is a block diagram of an electronic device in accordance with an exemplary embodiment.

FIG. 2 is a schematic view of an interface, displaying a one-level file path on the electronic device of FIG. 1.

FIG. 3 is a schematic view of an interface displaying a two-level file path on the electronic device of FIG. 1.

FIG. 4 is a schematic view of an interface, displaying a three-level file path on the electronic device of FIG. 1.

FIG. 5 is a schematic view of an interface, displaying a four-level file path on the electronic device of FIG. 1.

FIG. 6 is a flowchart of a navigation display method applied in the electronic device of FIG. 1 in accordance with an exemplary embodiment.

### DETAILED DESCRIPTION

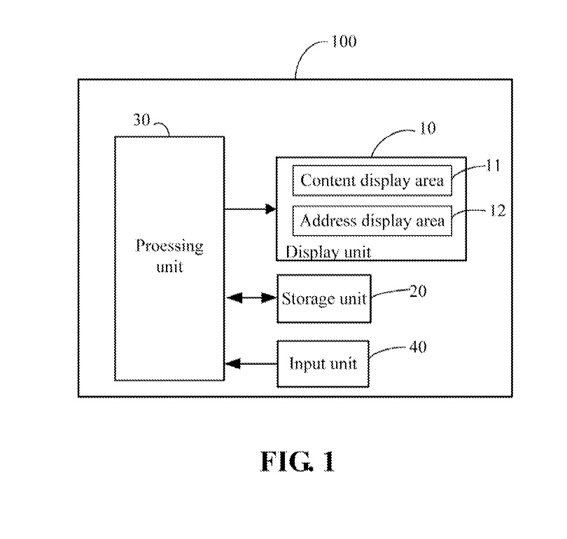

Referring to FIG. 1, an electronic device 100 includes a display unit 10, a storage unit 20, a processing unit 30, and an input unit 40. In the embodiment, the storage unit 20 stores text files, picture files, and audio files. The input unit 40 is configured to receive operations of the user and produce signals to signal the processing unit 30 according to the operations of the user. The display unit 10 is a touch display device and is configured to open a window in response to the operations of the user. The processing unit 30 is configured to change a file path according to file search operations and display a user interface under a current file path in the window. In the embodiment, the user interface comprises a content display area 11 and an address display area 12. The address display area 12 is provided for displaying a plurality of folder icons associated with the corresponding folders and arranged in a sequence such that the folder icons cooperatively presenting a file path to a current hierarchical folder. The content display area 11 is provided for displaying contents contained in the hierarchical folder. In the embodiment, a folder icon or a combination of a number of folder icons presents the current file path shown in the address display area 12. Each folder icon represents a level in the hierarchy of the current file path and is selectable and accessibleby the user. The contents are selected from the group consisting of files, webpages, folders, links, and any combination thereof. The processing unit 30 is further configured to the processing unit is configured to control the display unit 10 to change the folder icons to display an updated file path to a selected folder associated with a selected folder icon and display contents stored in the selected folder in the content display area 11. In the embodiment, the processing unit 30 is configured to control the display unit 10 according to a mapping table, the mapping table records mapping relationship between the folder icons and the folders. The folder icons correspond to the icons of system files or system folders. The mapping table is stored in the storage unit 20.

In the embodiment, each folder icon and the relationship table are pre-stored in the storage unit 20, the processing unit 30 reads and displays the folder icons in the address display area 12 according to the file path of current contents and the relevance of each folder icon and the file path.

In detail, for example, if a user wants to search for a particular book “The Road to Serfdom”, suppose the particular book is stored under “Home Page/My Library/Book shelf/Finance”, the hierarchy of the file path of “The Road to Serfdom” comprises four levels that are “Home Page”, “My Library”, “Book shelf” and “Finance” from the top to the bottom.

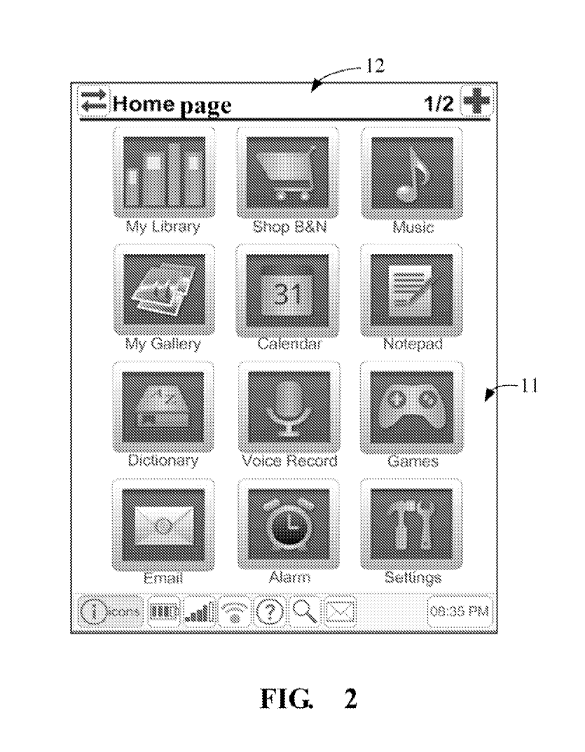

Referring to FIG. 2, when the user searches for the particular book by operating the input unit 40 to enter the “Home Page”. The processing unit 30 acquires the “Home Page”, and controls it to display contents under the “Home Page” in the content display area 11, by way of example, the content includes folders “My Library”, “My Gallery”, A1, A2, A3, . . . etc. The processing unit 30 also controls to display a folder icon corresponding to the “Home Page” in the address display area 12.

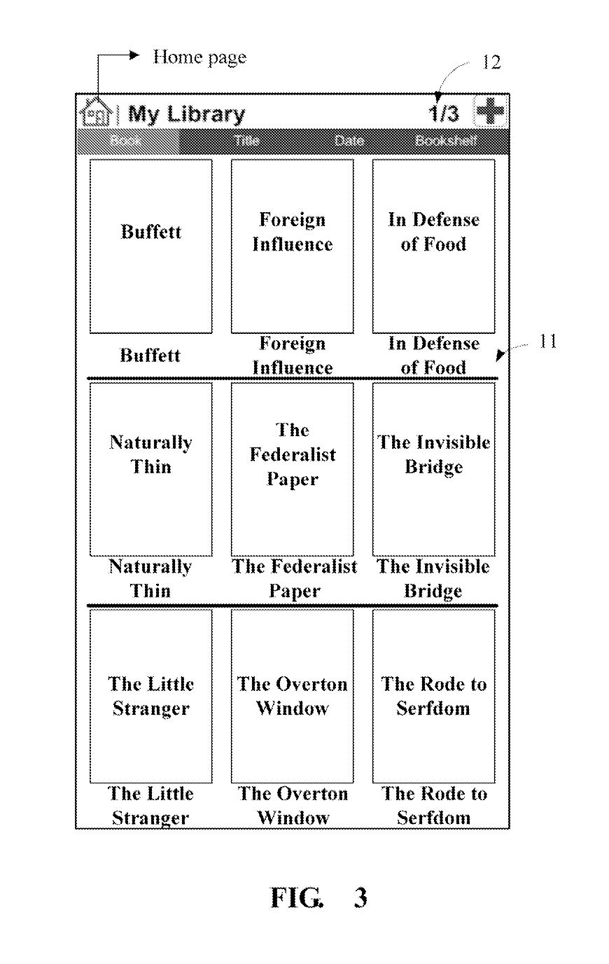

Referring to FIG. 3, when the user further forwards to the folder “My Library” in the content display area 11, the processing unit 30 updates the content display area 11 to display corresponding contents under “Home Page/My Library”, by way of example, the corresponding contents includes “Book shelf”, B1, B2, B3, . . . etc. The processing unit 30 further updates the address display area 12 to display a folder icon corresponding to the “My Library” after the folder icon of the “Home Page”.

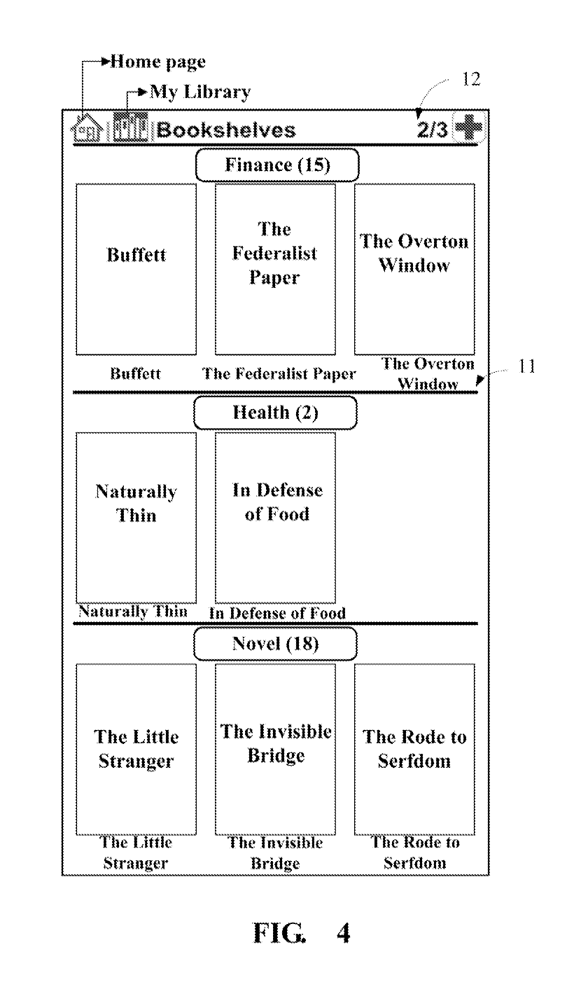

Referring to FIG. 4, when the user further forwards to the folder “Book shelf” in the content display area 11, the processing unit 30 updates the contents display area 11 to display contents under “Home Page/My Library/Book shelf”, by way of example, the contents includes “Finance”, C1, C2, C3 . . . etc. The processing unit 30 further updates the address display area 12 to display a folder icon corresponding to the “Book shelf” after the folder icon of the “My Library”.

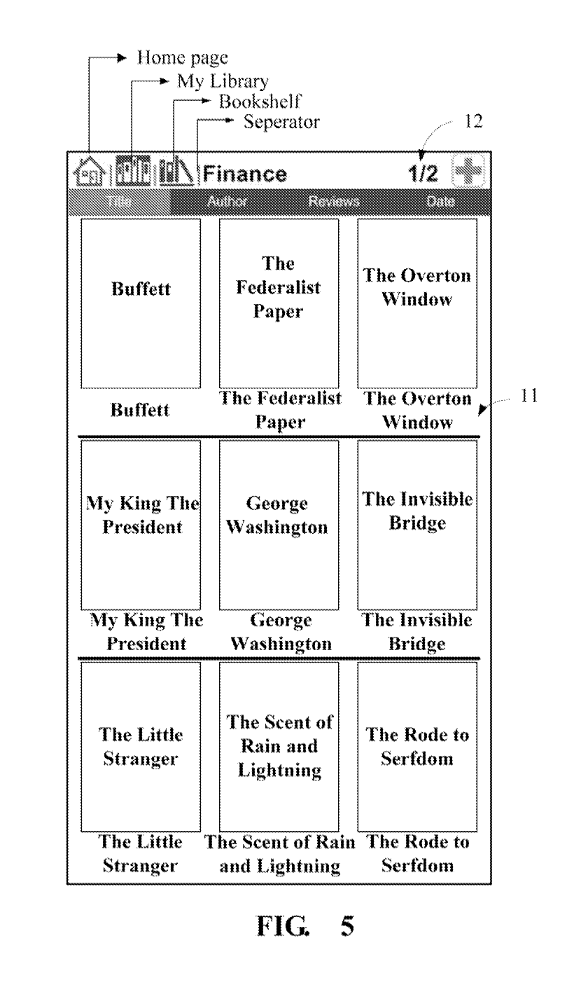

Referring to FIG. 5, when the user further forwards the file “Finance”, in the content display area 11, the processing unit 30 updates the content display area 11 to display content under the “Home Page/My Library/Book shelf/Finance”, by way of example, the content includes “The Road to Serfdom” and other books. The processing unit 30 further updates the address display area 12 to display a folder icon of “Finance” after the folder icon of the “Book shelf”.

In the present embodiment, the folder icons in the address display area 12 are selectable by the user who operates the input unit 40. If the user selects a folder icon in the address display area 12 by operating the input unit 40, the processing unit 30 updates the current file path to the level corresponding to the selected folder icon, and updates the content in both the address display area 12 and the content display area 11 accordingly. For example, if the user selects the folder icon corresponding to “My Library” in the address display area 12 of the user interface shown in either FIG. 5 or FIG. 4. The current file path is changed to “Home Page/My Library”, and displays the folder icons corresponding to “Home Page” and “My Library” in the address display area 12, and displays contents under the file path “Home Page/My Library” in the content display area 11 as shown in FIG. 3. If the user selects the folder icon “Bookshelf” in the address display area 12 of the user interface shown in FIG. 5. The current file path is changed to “Home Page/My Library/Bookshelf”, and displays the folder icons of “Home Page”, “My Library” and “Bookshelf” in the address display area 12, and displays contents under the file path “Home Page/My Library/Bookshelf” in the content display area 11 as shown in FIG. 4.

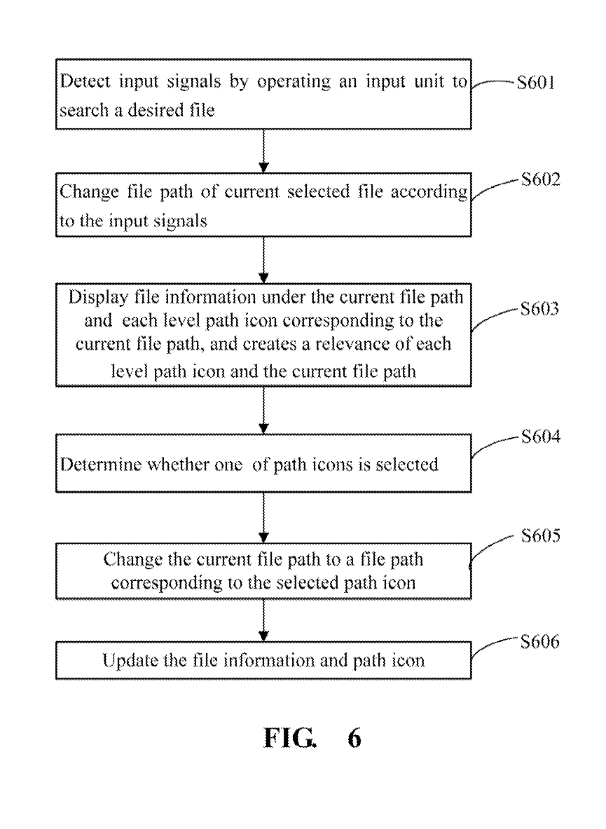

Referring to FIG. 6, a navigation display method applied in the electronic device 100 is provided.

In step S601, the processing unit 30 detects input signals by operating an input unit 40 to search a desired file.

In step S602, the processing unit 30 displays displays an user interface under a current file path in a window according to the input signals, the user interface includes a content display area 11 and an address display area 12. The address display area 12 is provided for displaying a plurality of folder icons associated with the corresponding folders and arranged in a sequence such that the folder icons cooperatively presenting a file path to a current hierarchical folder. The content display area 11 is provided for displaying contents contained in the hierarchical folder. The contents are selected from the group consisting of files, webpages, folders, links, and any combination thereof.

In step S603, the processing unit 30 determines whether a folder icon in the address display area 12 is selected.

If a folder icon is selected, in step S604, the processing unit 30 changes the folder icons in the address display area 12 to display an updated file path to a selected folder associated with the selected folder icon, and displays contents stored in the selected folder in the content display area 11. Other wise, the procedure returns to the step S601.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
an input unit configured for generating input signals based on the user's operations;
a storage unit configured for storing contents, the contents stored in folders organized in a hierarchical folder structure;
a display unit configured for displaying a user interface, the user interface including a content display area and an address display area, the address display area configured for displaying a plurality of folder icons, the folder icons associated with the corresponding folders and arranged in a sequence such that the folder icons cooperatively presenting a file path to a current hierarchical folder, the content display area configured for displaying contents contained in the hierarchical folder; and
a processing unit configured for controlling the display unit to change the folder icons in the address display area according to the users' operations to display an updated file path; and
updating content in the content display area accordingly.

2. The electronic device as claimed in claim 1, wherein each of the folder icons is selectable and accessible by the user and the processing unit is configured to control the display unit to change the folder icons to display an updated file path to a selected folder associated with the selected folder icon and display contents stored in the selected folder in the content display area.

3. The electronic device as claimed in claim 1, wherein the contents are selected from the group consisting of files, webpages, folders, links, and any combination thereof.

4. The electronic device as described in claim 1, wherein the display unit is a touch display device.

5. The electronic device as described in claim 1, wherein the processing unit is configured to control the display unit according to a mapping table, the mapping table records mapping relationship between the folder icons and the folders.

6. The electronic device as described in claim 5, wherein the mapping table is stored in the storage unit.

7. A navigation display method applied in an electronic device, the electronic device including a display unit and a storage unit storing contents, the contents stored in folders organized in a hierarchical folder structure, the method comprising:
displaying an user interface on display unit, the user interface including a content display area and an address display area;
displaying a plurality of folder icons, the folder icons associated with the corresponding folders and arranged in a sequence such that the folder icons cooperatively presenting a file path to a current hierarchical folder; and
displaying contents contained in the hierarchical folder.

8. The method as described in claim 7, further comprising:
determining whether one of the folder icons in the address display area is selected according to the users' operations;
changing the folder icons in the address display area to display an updated file path to a selected folder associated with the selected folder icon; and
displaying contents stored in the selected folder in the content display area.

9. The method as described in claim 7, wherein the contents are selected from the group consisting of files, webpages, folders, links, and any combination thereof.

10. The method as described in claim 7, wherein the folder icons correspond to the icons of system files or system folders.

11. The method as described in claim 7, wherein displaying an updated file path to a selected folder associated with the selected folder icon according to a mapping table, the mapping table records mapping relationship between the folder icons and the folders.

12. The method as described in claim 11, wherein the mapping table are preset stored in a storage unit.
